(19) United States
(12) Patent Application Publication
(10) Pub. No.: US 2019/0264453 A1
(43) Pub. Date: Aug. 29, 2019

(54) MODULAR FORMWORK SYSTEM FOR PRODUCING CONCRETE ELEMENTS

(71) Applicant: BIGREP GMBH, Berlin (DE)

(72) Inventor: Jorg Petri, Berlin (DE)

(21) Appl. No.: 16/340,836

(22) PCT Filed: Oct. 10, 2017
(86) PCT No.: PCT/DE2017/100855

§ 371 Date: Apr. 10, 2019

(30) Foreign Application Priority Data
Oct. 11, 2016 (DE) 10 2016 119 365.8

(51) Int. Cl. E04G 13/02; E04G 11/04; E04G 17/02; E04G 9/10; B29C 33/38; B33Y 80/00; E04G 9/02

(52) U.S. Cl. CPC E04G 13/02; E04G 11/04; E04G 17/02; E04G 2009/028; B29C 33/3842; B33Y 80/00; E04G 9/02; E04G 9/10

(57) ABSTRACT

The invention relates to a modular formwork system (1) for producing concrete elements (20), consisting of a plurality of individual moulds (2), said individual moulds (2) being produced at least on the surface (3) which faces the concrete, which is made of a plastic (4) that is cured layer by layer. The invention also relates to a method for producing the formwork system, and to a washer device for washing same.

The present invention relates to a modular formwork system for producing concrete elements, to a method for producing such a formwork system and to a washer device for use with such a formwork system.

According to the prior art, formworks for producing concrete elements are produced from numerous materials and in numerous different embodiments. The materials include wood, iron, aluminum and also plastic.

In the case of wall formwork, use is made, for example, of formwork panels of aluminum which are connected to one another, are laterally supported and are then filled with concrete.

After curing the concrete, which temperature-sensitive, the formwork panels are usually removed (unless permanent formworks are concerned) and can be reused.

The prior art also discloses structured formworks which can imprint a certain texture on the surface of the concrete wall.

If these structured formworks are manufactured from a flexible plastic, such as, for instance, polyurethane, it is possible for even slight undercuts to be imprinted on the wall.

However, with regard to the degree of the undercuts, one is limited with the devices and methods known from the prior art.

Moreover, in the case of structured formworks, it is usually too cost-intensive to concomitantly achieve a texture which is individual or varies in certain portions.

Accordingly, the object of the present invention consists in eliminating the disadvantages known from the prior art and in increasing the design freedom in concrete casting.

This object is achieved according to the invention by a modular formwork system as claimed in claim 1, a method for producing a modular formwork system as claimed in claim 11 and a washer device for use with the modular formwork system as claimed in claim 15.

The subclaims present preferred embodiments of the invention.

Here, the formwork module according to the invention can be assembled from a plurality of individual molds. At least on the side of the individual mold that faces the concrete in the application case, the surface is produced from a plastic which is cured in layers.

Especially within the context of additive manufacturing, such a plastic is preferably produced in this specific case by means of fused deposition modeling (FDM) or, better still, fused filament fabrication (FFF). An object manufactured in such a way can generally be distinguished from cast plastic objects in that its breaking strength is less. This has the advantage that the mold can be better released subsequently.

In addition, individually formed surfaces, undercuts and complicated structures can be offered in a considerably more favorable manner with plastics cured in layers in the FFF process.

The modular formwork system preferably has at least one device for fixing. This can take the form, for example, of clamping straps by means of which the individual molds are connected to one another.

According to a further embodiment, the individual molds have, for this purpose, cutouts and projections which serve for anchoring the clamping straps. In order to further simplify the horizontal and vertical positioning of the individual molds relative to one another, according to a further embodiment there is provision that the individual molds can be connected via tongue and groove connections.

According to a further embodiment of the invention, there is provision that the individual molds are manufactured from a recyclable base carrier or base plate and a recyclable plastic which can be released from the base carrier. The recyclable plastic is preferably the plastic which is cured in layers. The component which can be released from the base carrier is the component facing the concrete. This component should have a high resolution in order to ensure the detail accuracy of the concrete surface. Since the printing time can be reduced in the case of a relatively small layer thickness, the high-resolution component should have as small a layer thickness as possible. The base plate or base carrier situated behind it can then preferably be produced with coarse resolution and should be designed such that the main loads of the concrete pressure can be taken up. The printed mold is thus preferably subdivided into two regions, wherein the side facing the concrete in the application case has a higher resolution than an adjoining side of the individual mold that faces away from the concrete. This division can be provided in the embodiment with or without base plate/base carrier.

Devices are preferably provided in the base plate that allow the recyclable plastic to be held during the concrete casting. These devices can be configured, for example, as cutouts through which a projection or a bulge of the recyclable plastic cured in layers is guided outward and braced in the mounted state. According to another embodiment, there can be provided a clip connection into which the recyclable plastic cured in layers is clipped in the mounted state. However, the base carrier can also be adhesively bonded in a force-fitting manner to the shaping component.

Here, the base plate can likewise be formed from a plastic but can, according to further embodiments, also be manufactured from another material, such as aluminum or wood, for example. The base plate can be digitally milled to be perfectly accurately fitting in order then to receive, with an accurate fit, the shaping component produced additively in the FFF process.

According to a further embodiment, there is provision that the shaping component as already described is produced in a relatively thin layer with high resolution, and, in addition, the external dimensions of the base plate are concomitantly printed in a component in this way. In order to ensure the static strength of the entire component, the component, as a large hollow body, is subsequently filled with a foam by spraying. This has the advantage that the large, load-bearing surface fractions of the overall component can be produced in a force-fitting and dimensionally stable manner in a short time. In this example, the individual mold is thus characterized in that the printed outer walls enclose an inner cavity which is filled with a solidified foam.

According to a further embodiment, there is provision that the individual molds are designed with different strengths dependent on the arrangement of the individual element within the formwork system in the application case.

For example, it is known that a higher hydrostatic force acts on the individual molds which are situated at the lower end of a wall to be cast than on the individual molds at the upper end of the wall. For this reason, there can be provision that the strength and density of the plastic of the formwork system that is cured in layers is greater in the lower wall region than in the upper wall region, or the individual molds are designed with different strengths dependent on the arrangement of the individual element within the formwork system in the application case.

According to a particular embodiment of the invention, there is provision that the shaping surface of the individual molds that faces the concrete is manufactured at least partially, that is to say in certain portions and/or with respect to a certain component of the surface, from a water-soluble plastic. This can be a PVA (polyvinyl alcohol)-based plastic or a comparable plastic with very good water-soluble properties.

This water-soluble plastic allows particularly simple release of the individual mold from the concrete element, for example the concrete wall, produced.

According to a further embodiment, there is provision that the water-soluble plastic contains at least one further constituent part. This can be, for example, a color pigment which, as a result of the partial dissolving of the water-soluble plastic, in the application case, penetrates through the concrete into the surface of the concrete and imparts a color to the concrete. These color pigments can be uniformly configured or can be arranged within the mixture of the water-soluble plastic such that a pattern or an image is obtained with respect to the overall formwork system.

According to a further embodiment, there can be provision that a material is arranged in the mixture of the water-soluble plastic, which material deposits in the curing concrete layer and changes the surface nature of the concrete.

According to a further embodiment, there is provision that the individual molds are built up from honeycomb structures at least in individual regions. These structures serve, on the one hand, for material saving. However, they can be formed in size such that, in the application case, concrete penetrates into the honeycomb structures, with the result that the honeycomb structures act, in certain portions, as mold cores.

These mold cores can be washed out by different methods after the concrete casting in so far as they are water-soluble plastics, or they can remain in the concrete.

There can also be provision that the individual molds partially have honeycomb structures which are partially water-soluble and partially non-water-soluble.

Thus, in the application case, permanent formworks can be left within the interior of the concrete, the water-soluble structures connected to the permanent formwork can be washed out, and, in a further step, the newly created cavities can be concreted again.

A corresponding modular formwork system then has, for example, a mold core which is connected to at least one individual mold via the plastic cured in layers. Depending on the design, the mold core can here also be part of the plastic cured in layers.

According to a further embodiment, there is provision that the individual mold at least one washing duct is provided in the region of the water-soluble plastic. As a result, a subsequent washing operation is quicker. With further preference, a plurality of washing ducts are provided.

If the mold core is for example one which is water-soluble, according to a further embodiment there can be provision that supporting structures are arranged in the interior of the mold core that prevent collapse of the mold core by the hydrostatic pressure of the concrete. These can likewise be designed to be water-soluble.

According to a preferred embodiment, there is provision that at least one individual mold has a device for the water-guiding fastening for a washer device. According to a further embodiment, each of the individual molds has at least one and preferably a plurality of devices for fastening a washer device, wherein the individual fastening devices can also be closed in a watertight manner. In this way, it is possible in the application case to wash out the water-soluble structures from many different sides.

As has already been indicated in the introductory part of the description, the present invention also comprises a method for producing the above-described formwork system.

Here, the method according to the invention comprises the following steps:

At first, the geometry and the size of each individual mold are determined in order that, after assembly thereof, the desired overall structure of the formwork system when assembling the individual elements is obtained.

The concrete element to be produced can be a wall, a window, but also a mixture between wall and window and any desired three-dimensional object.

The geometry can be determined by means of computer-aided construction programs.

On the basis of these data, at least the regions of the individual molds that face the concrete in the application case are then printed. According to another embodiment, the entire individual mold can also be printed.

Examples of plastics which can be used are PLA and PVA.

The plastic used for printing is preferably recyclable.

According to a further embodiment, this preferably recyclable plastic is printed onto a reusable base carrier, or the printed plastic is subsequently connected thereto.

According to one particular embodiment, the individual mold or a component connected thereto, such as the base carrier, has a memory on which information on the individual mold or on the plastic printed on it or connected to it contained during the printing. With further preference, this memory (for example ID tag) can be read when building up the overall formwork system and, with further preference still, is designed such that it provides information to the fitter on the arrangement and position of the corresponding individual mold. A digital ID tag could also be spoken of in this case.

According to various modifications of the method according to the invention, there is provision that a water-soluble plastic is used for printing. This can be provided, for example, at the point where the concrete bears against the individual mold in the application case. According to other variants, cavities which can be washed out are subsequently printed hereby.

According to different variants, materials having one or more rates of solubility can be provided.

As has already been mentioned in the introductory part of the description, a washer device which can be used for the formwork system is also one aspect of the present invention.

Such a washer device is intended, preferably on the building site, to wash out the water-soluble components of the formwork system and at the same time to clean the washing liquid for further use during the washing operation.

For this purpose, the washer device has a water reservoir, a pump, a washing liquid feed unit for connecting the washer device to the modular formwork system, for example a hose, a tube or a flange.

In addition, the washer device has a washing liquid removal unit which can likewise be configured, for example, as a hose, tube or flange.

A separating unit is provided in order to separate the dissolved plastics and/or further washed-out constituent parts from the washing liquid. This can be a filter, gravity separator, chemical separator or other separator.

Further details are explained on the basis of the following drawings, wherein the figures reflect details of particular embodiments.

### IN THE DRAWINGS

FIG. 1 shows the digital workflow for determining the individual molds,

FIG. 2 shows the printing of the individual molds,

FIG. 3 shows the building site mounting and concrete casting,

FIG. 4 shows the comminution and the recycling,

FIG. 5 shows devices for fixing the individual elements,

FIG. 6 shows a pillar-shaped formwork system,

FIG. 7 shows individual molds of different stability,

FIG. 8 shows a honeycomb structure,

FIG. 9 shows a plastic cured in layers,

FIG. 10 shows components particularly predestined for the formwork system,

FIG. 11 shows a concrete element having a water-soluble mold core,

FIG. 12 shows the concrete element from FIG. 11 without mold core,

FIG. 13 shows an overview of the method steps for an implementation of the invention,

FIG. 14a shows two individual molds which have different structure densities in cross section,

FIG. 14b shows the individual molds from FIG. 14a which are placed on base carriers.

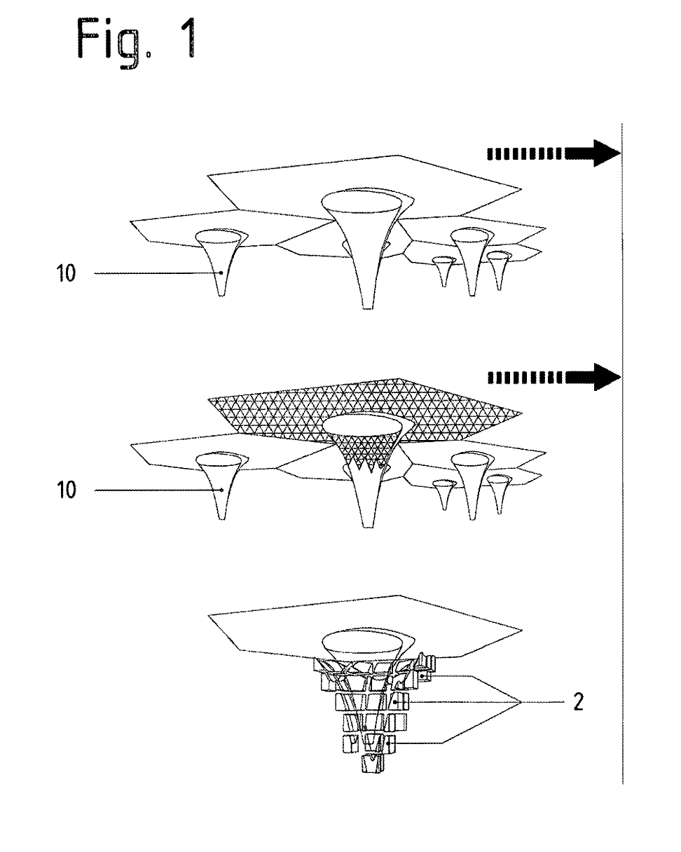

FIG. 1 shows the digital workflow which is executed according to one embodiment of the invention in order to produce the individual molds 2.

Here, a model for the required wall thicknesses of the concrete object is computed from the computer-aided computer program to map three-dimensional objects. From this model there is calculated an overall mold which is ultimately subdivided into the individual molds 2.

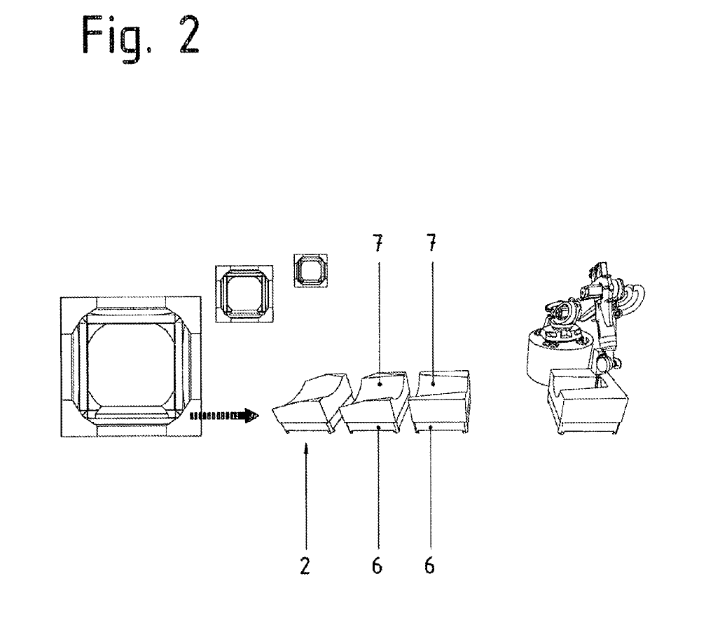

FIG. 2 shows the way in which the individual molds 2 are produced. According to the embodiment shown here, use is made of base carriers 6 which are preferably designed to be moved in a manufacturing line for 3D printing. For this purpose, the base carriers 6 preferably have memories on which information from the manufacturing line for 3D printing can be stored. In addition, markings for sensors of the manufacturing line are preferably fastened on the base carrier. The recyclable plastics are then printed onto the base carrier, as has previously been computed. The base carrier 6 forms, together with the printed-on plastic, the respective individual mold 2. In a further step, a post treatment of the mold by means of, for example, application of a lubricant (formwork grease) or the removal of overhangs can be provided.

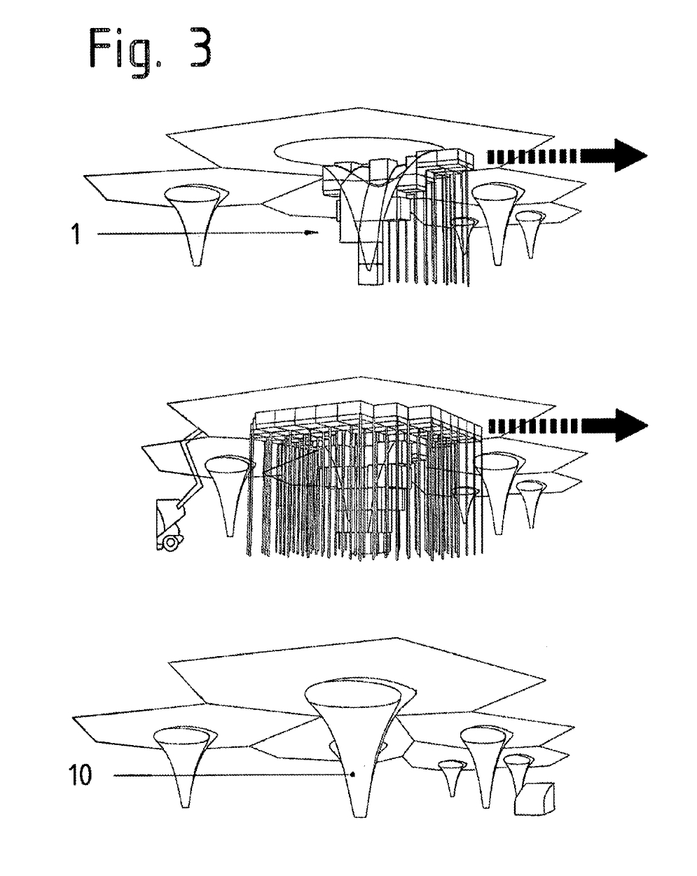

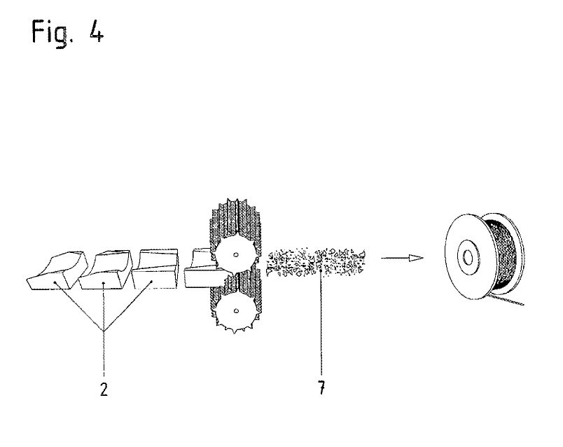

FIG. 3 shows how the individual molds 2 are brought into position on the building site. In a manner not shown here, the fitter here uses the information stored on the memory unit of the base carriers 6 and a suitable information playback unit, such as, for instance, a graphic/virtual display of the construction that is to be carried out in space. After the individual molds have been positioned and fixed, the formwork system 1 is filled with concrete. After curing, the individual molds 2 are removed and the concrete object 10 is completed.

FIG. 4 shows that, after the concrete casting, the plastics 7 applied to the base carrier 6 are released from the base carrier 6, comminuted, melted and then reprocessed again to form a filament which can be used for further printing.

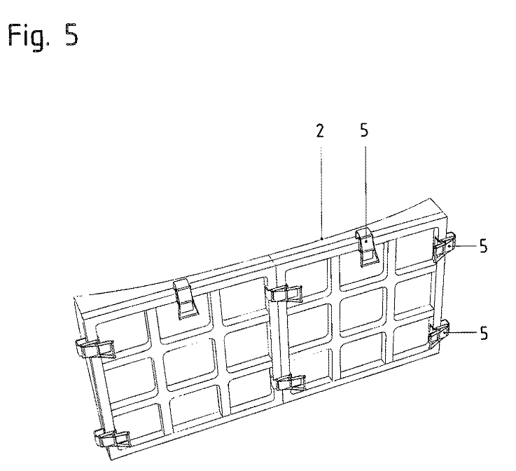

FIG. 5 shows an individual mold 2 which has devices for fixing on its base carrier 6. As illustrated here, use is made of clamping straps. However, other types of connection can also be chosen.

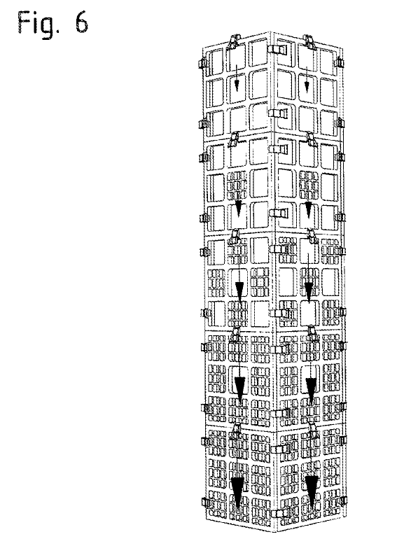

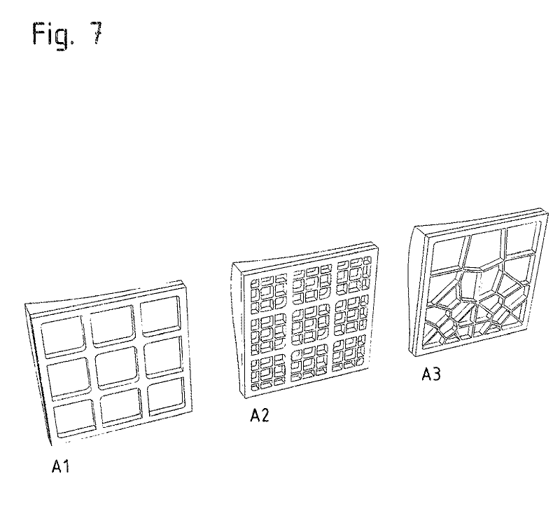

FIG. 6 shows a cuboidal formwork system 1. By virtue of its height and the expected hydrostatic forces, it has been decided in this case to configure the individual molds 2 to have different strengths. Here, different rib structures have been used, as is shown in FIG. 7.

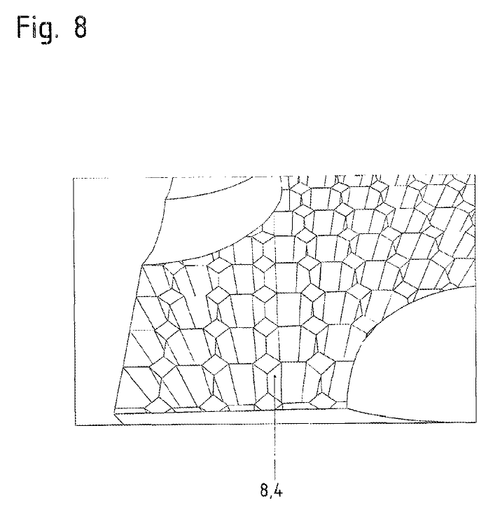

FIG. 8 shows a honeycomb structure 8. In the context of the invention, the term “honeycomb” is preferably to be interpreted in broad terms and preferably refers not only to the structure illustrated here but to all structures having regular bridges and spaces formed thereby. According to a further embodiment, irregular bridges and the spaces formed thereby also together count among such structures.

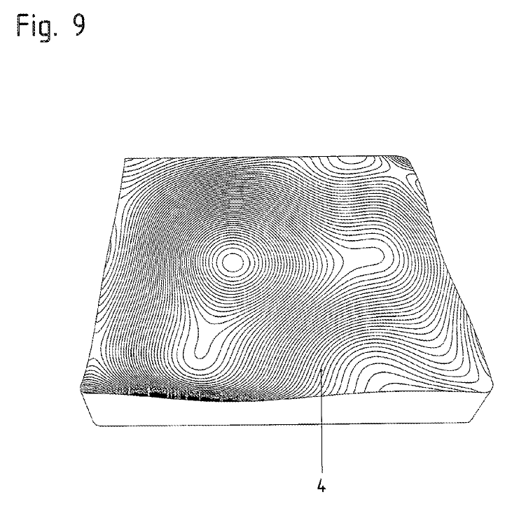

FIG. 9 shows a plastic 4 cured in layers. The honeycomb structure from FIG. 8 is also built up in layers. However, in this figure, the grain can be clearly seen and patterns the concrete mold.

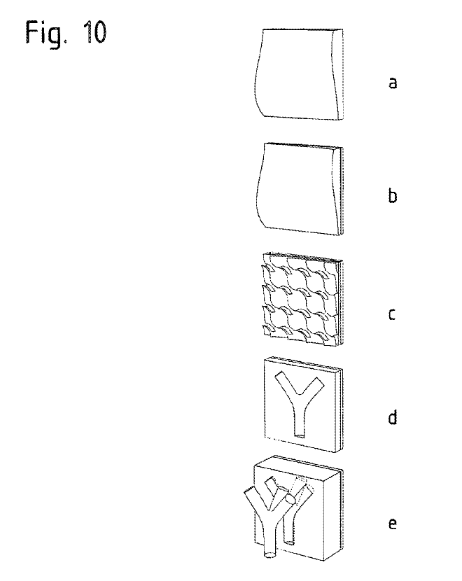

FIG. 10 shows particularly predestined objects for the formwork system 1 according to the invention. A: Large-area concrete components (walls, supports, ceilings, facade components). The formwork system consists of a material: PLA (biodegradable, recyclable) and can be chipped after use in order to be printed again.

B: Large-area concrete components (walls, supports, ceilings). The formwork system consists of two materials: Basic structure consisting of PLA (biodegradable, recyclable), only the formwork surface consists of PVA (biodegradable, water-soluble, recyclable) and can be washed out after use and be printed on again for the next component.

C: Large-area concrete components (walls, supports, ceilings, facade components) having integrated, complex undercuts and cavities. The formwork system is a hybrid of PVA (biodegradable, recyclable) and PLA (biodegradable, water-soluble, recyclable). After the concrete has cured, the cavities provided are washed out with water.

D, E: Node components—the formwork system as hybrid of PLA (biodegradable, recyclable) and PVA (biodegradable, water-soluble). New nodes can be created at any time in that the surface-relevant.

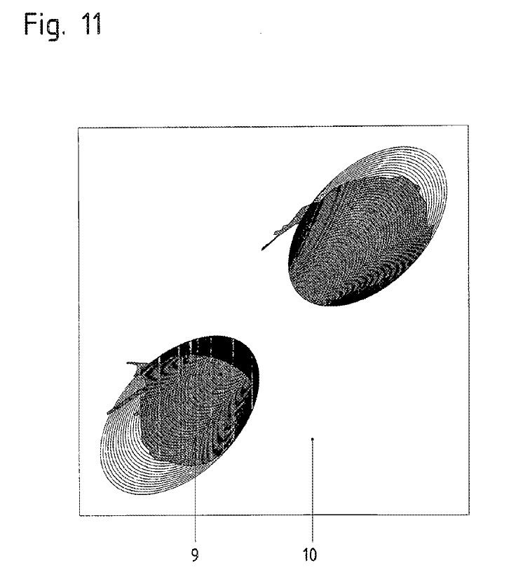

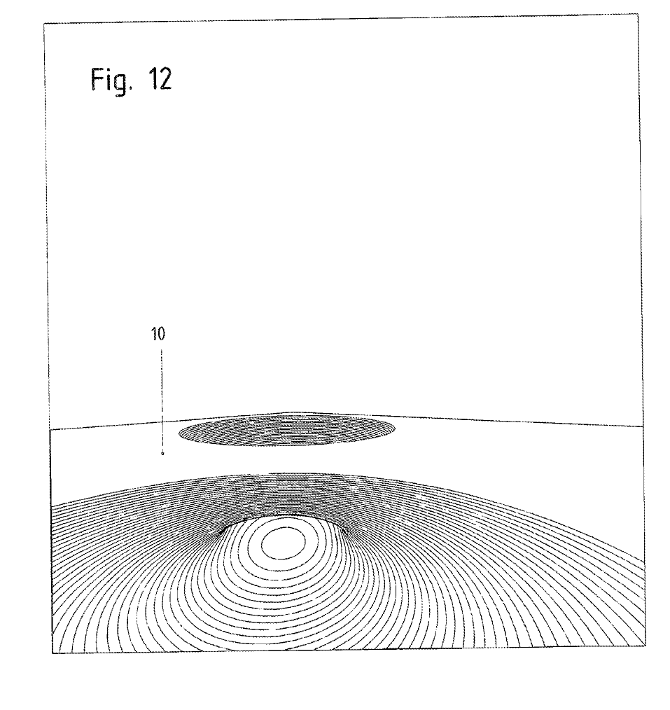

FIGS. 11 and 12 show a concrete element 10 having a water-soluble plastic 9 which here forms a mold core.

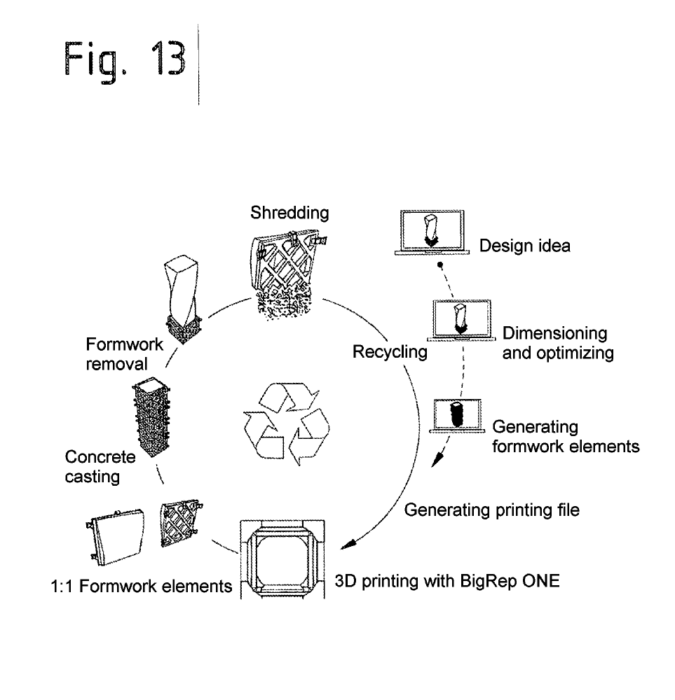

FIG. 13 shows once again a particularly preferred embodiment of the method according to the invention.

If a concrete component, for example a column or a pillar, is intended to be cast, first of all a design is then preferably created on the PC. The dimensions are determined as the next step. The individual formwork elements/individual molds 2 are then computed and passed onto a 3D printer. This prints the individual molds 2 either directly with fastening elements, for example cutouts in which devices for fixing 5 can engage, or onto base carriers 6 which for their part have fastening elements. A memory in which information on the individual mold 2 and, where appropriate, its position in the formwork system 1 is automatically stored is preferably mounted on an individual mold 2.

The individual molds are then assembled on the building site to form the formwork system 1 while taking account of the information stored on the memory.

In the assembled state, the correct positioning of the individual molds can also be checked once again via the stored information. Here, according to one embodiment, the individual memories of the adjoining individual molds 2 of the formwork system 1 can be read in succession. If two individual molds 2 lie next to one another that should not lie next to one another, a warning signal is emitted.

After determining the correct assembly of the formwork system 1, the latter is filled.

According to a variant (not shown here), a washing device is then connected to two or more points of the formwork system 1, the formwork system 1 being designed to receive said device in a sealing manner. Soluble parts of the individual molds 2, if present, are subsequently washed out.

The formwork system 1 is removed thereafter. The individual molds are subsequently shredded, recycled and the material resulting therefrom reused.

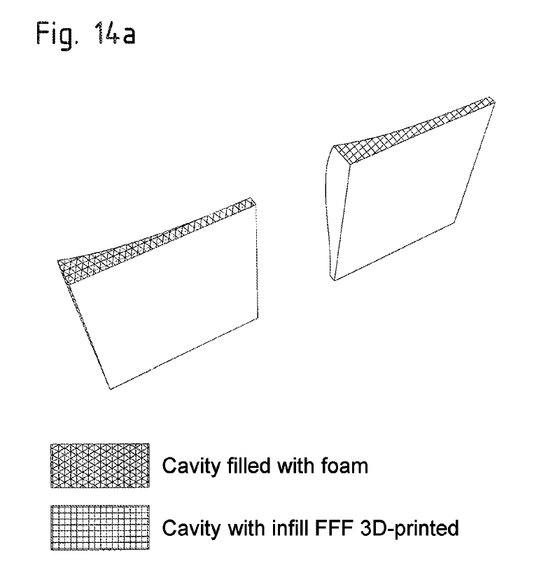

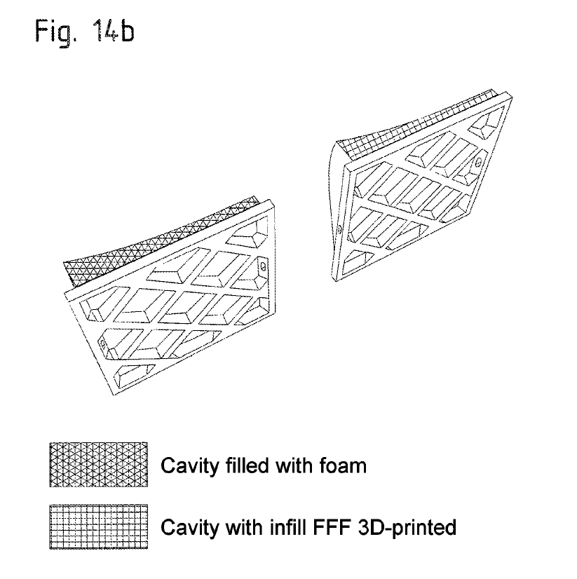

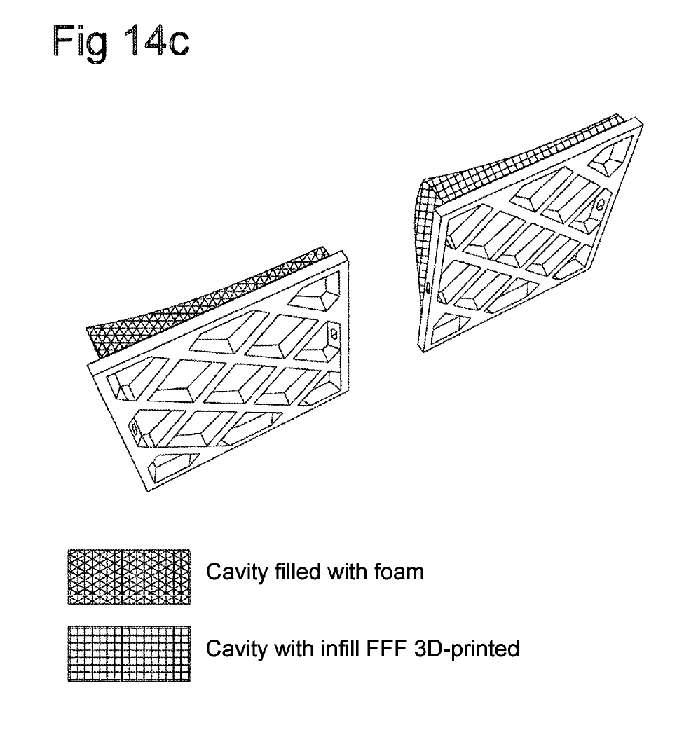

FIGS. 14a and 14b show two different solutions as to how there can be achieved a quick production rate of the individual molds 2 in spite of high resolution of the surface facing the concrete. One possibility consists in printing the outer surfaces of the individual mold 2, with the result that an interior is enclosed, and, during the printing or after the printing of the outer surfaces, to fill the interior of the individual mold with a self-curing foam by spraying. Here, the foam can be applied with a second printing head, or the foam is injected through an opening after printing the outer surfaces. This operation leads in short time to an individual mold 2 which has a high resolution, which is necessary for face concrete, of the surface facing the concrete and is dimensionally stable at the same time in order to be able to take up the forces necessary for the operation. There can also be provision that the interior provided for filling by spraying with the self-curing foam is not formed by the individual mold 2 itself but by the individual mold 2 together with the base carrier 6. Here, for example, a peripheral side wall of the individual mold can engage in a peripheral side wall of the base carrier, resulting in a sealed interior.

Another solution consists, instead of foaming, in selecting a printing method in the interior of the individual mold, which has a smaller resolution than the outer surfaces of the individual mold 2. For this purpose, use can be made, for example, of honeycomb structures 8 which are applied with a second printing head. Whether foaming or printing, a layer adjoining the high-resolution layer has a lower resolution in both cases. It is shown in FIG. 14b how these individual molds 2 are placed on the base carriers 6. This can occur, for example, by a clip connection or adhesive connection (not shown here). The base carrier 2 is, preferably for weight reduction, also not configured to be solid but comprises supporting structures in its interior.

### LIST OF REFERENCE SIGNS

1 Formwork system

2 Individual molds

3 Surface facing the concrete

4 Plastic cured in layers

5 Device for fixing

6 Base carrier

7 Recyclable plastic

8 Honeycomb structures

9 Water-soluble plastic

10 Concrete element

1. A modular formwork system for producing concrete elements comprising: a plurality of individual molds, wherein the individual molds are produced, at least on the surface facing the concrete elements, from a plastic with a high-resolution surface that is cured in layers in an additive manufacturing process, and wherein the individual molds additionally have a printed or foamed layer with a lower resolution that adjoins the high-resolution surface.

2. The modular formwork system as recited in claim 1, characterized in that the formwork system includes at least one device for fixing the individual molds.

3. The modular formwork system as claimed in claim 1, characterized in that the individual mold or a component connected thereto includes a memory on which information on the individual mold is stored.

4. The modular formwork system as claimed in claim 1, characterized in that the individual molds are manufactured from a recyclable base carrier and a releasable plastic which can be recycled for reuse in 3D printing.

5. The modular formwork system as recited in claim 1, characterized in that the plurality of individual molds comprise at least one layer of cured foam.

6. The modular formwork system as recited in claim 1, characterized in that the plurality of individual molds are at least partially built up from honeycomb structures.

7. The modular formwork system as recited in claim 1, further comprising at least one mold core which is connected to at least one individual mold of the plurality of individual molds via plastic which is cured in layers.

8. The modular formwork system as recited in claim 7, characterized in that the mold core is at least partially formed from a water-soluble plastic.

9. The modular formwork system as recited in claim 8, characterized in that at least one washing duct is provided in the region of the water-soluble plastic.

10. The modular formwork system as recited in claim 9, characterized in that the washing duct comprises water-soluble supporting structures in its interior.

11. The modular formwork system as recited in claim 5, characterized in that at least one individual mold of the plurality of individual molds includes a device for the water-guiding fastening of a washer device.

12. A method for producing a formwork system for concrete construction, comprising the following steps of:
determining the size and geometry of a plurality of individual molds from which the formwork system is assembled;
printing at least one high-resolution surface, which faces the concrete elements, of at least one individual mold through an additive manufacturing technology from plastic cured in layers;
printing or foaming a layer with lower resolution that adjoins the high-resolution surface; and
assembling and filling the formwork system.

13. The modular framework system as recited in claim 4, characterized in that the surface facing the concrete elements is produced from a recyclable plastic material.

14. The modular framework system as recited in claim 4, characterized in that the plurality of individual molds are formed from a recyclable base carrier on which a surface facing the concrete is printed through an additive manufacturing technology, the surface being detachable for reuse of the base carrier.

15. The modular framework system as recited in claim 14, characterized in that the surface facing the concrete element is at least partially printed from a water-soluble plastic.
